(19) United States
(12) Patent Application Publication
(10) Pub. No.: US 2009/0149251 A1
(43) Pub. Date: Jun. 11, 2009

(54) Casino service and display unit

(76) Inventor: Edwin Sanchez, Atwater, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 11/999,847

(22) Filed: Dec. 6, 2007

(51) Int. Cl. A63F 13/00

(52) U.S. Cl. 463/31

(57) ABSTRACT

The present invention is a casino table service display system in which an elevated sign is placed in proximity to a casino table to provide information regarding the game being played at the casino table, service required at the table and other information, including advertising and entertainment that may be desired at the table. The casino table service display contains a telescoping support attached to a mounting plate for securing the system to a fixed surface. A display unit secured to the support may be provided with a table upper bet limit indicator, a table lower bet limit indicator, a table number indicator, one or more advertisement display panels, one or more game information display panels, and a two-way speaker system, any or all of which may be in communication with a remote location. In a preferred embodiment, the system has service and chip lights secured to the display unit in communication with activation switches on the support member.

### BACKGROUND OF THE INVENTION

1. Field of the Invention

The present invention relates to visual display for use at casino table games that displays information to the gaming public and casino employees, including displays for advertising and gaming information, and signals for service requests.

2. Description of the Prior Art

In the casino and gaming industry gaming tables are used for a wide variety of games. Gaming tables have been in existence for a very long time and come in a variety of shapes and sizes. In a common embodiment, casino gaming, tables are half-circular shaped tables where players sit on the curved side of the table and a dealer is situated at the straight surface forming the diameter of the half-circle. The flat surface of the table faces towards the interior of a pit area. Tables can be constructed of many materials, and the upper table surface is usually covered in padded felt, many times marked with various designs for different games.

Commonly casinos use table displays in the form of small signs sitting on the corner of a table which describe the game being played and the betting limits of the table. As the informational signs are ordinarily at the level of the table, they can be hard to see through a crowded casino. Further, the signs are not very informative, so that customers may have to ask the dealer to find out any special rules of the game being played. This can cause a loss of players and income for casinos as many players may not be willing to spend the time to fight through crowds to find out the game limits of the tables in the areas, and find open seats at a table.

Casinos may use other signage to describe the general gaming-tables in the area, but many times the signage is fixed for the area, and not able to be changed, preventing the tables to be used for more than one purpose.

It is therefore desirable to provide a casino table display apparatus that is capable of displaying information regarding the gaming played on the table, displaying other information including advertising, and that allows for the requesting of needed assistance, service or security. It is also desirable to provide similar advertising and information displays as well as service requests in other applications such as retail sales counters, restaurants tables and establishments providing drive-through services.

### SUMMARY OF THE INVENTION

The present invention provides a casino table service display system in which an elevated sign is placed above or next to a casino table to provide information to customers and employees such as the game being played at the casino table, service required at the table and other information, including advertising and entertainment that may be desired at the table. In the preferred embodiments of the invention, the casino table service display includes a telescoping tubular support attached to a mounting plate for securing the service display to a fixed surface (such as the floor or a gaming table), a display unit secured to the top of the tubular support for the display of information. In alternative embodiments, additional features may be provided individually or in different combinations, such as without limitation: a table upper bet limit indicator, a table lower bet limit indicator, a table number indicator, one or more advertisement display panels, one or more game information display panels, and a two-way speaker system, and/or one or more signal lights and associated switches (for requesting refreshments, chips, service, service, technical support, emergency aid, etc.). These additional features may be in operable communication to a remotely accessible processing unit. In some embodiments, a service light is secured to the display unit and in communication with a service light switch attached to the telescoping tubular support, and a chip light is secured to the display unit and in communication with a chip light switch attached to the telescoping tubular support.

In most embodiments, the display unit that is placed in an elevated location by a tubular support which extends in a downward direction from the display unit. In these embodiments, the tubular support unit is attached to a mounting unit which is secured by fastening means to a surface. The mounting unit has one or more holes to allow for the mounting unit to be attached to a generally flat surface by fasteners such as screws or nails. The surface can be but is not limited to the floor, or the underside of a casino gaming table. In an embodiment where the mounting unit is secured to the underside of a gaming table, the tubular support may be curved as much as 180° (forming a “J” shape) to allow the support to be secured to the lower side of the mounting unit. In these embodiments, the mounting unit has a flat upper surface for mating to and being secured by one or more fastening devices to the underside of a gaming table.

In most embodiments, the tubular support is telescoping in nature so that it can be extended or retracted to a preferred height of the user. In these embodiments, the tubular support is rotatable allowing the user of the display to rotate the display unit to a preferred direction. It is to be appreciated that non-telescoping and/or non-tubular support members may be used in alternative embodiments.

Most embodiments are provided with at least one service light and corresponding control switch. Other embodiments may be provided with additional lights and related control switches for for such things as chip requests, raise/lower bets, on/off bets, etc. The control switches are preferably located on the support shaft in order to make the entire unit more easily transportable, but they may also be provided on a separate switch pad that may or may not be attached to the casino table.

A display panel is securely attached to the top of the support shaft. The display panel has at least one flat surface on which information can be displayed. The display panel may have one or more advertising displays on the flat surface. The embodiments of the advertising displays include, but are not limited to, a fixed display, a back lit display, and a light-emitting diode (LED) display. The advertising displays allow for the quick interchange of different information, or a continuous stream of information. The display panel may provide information regarding the gaming taking place at the table, including without limitation the name or title of the game being played, the maximum and minimum bets allowed at the table, the status of the game (raise/lower bets, on/off bets, etc.), and further information regarding the game such as instructions to play.

The display unit may also be optionally equipped with a speaker and two way intercom systems. The optional speaker system can convey audio to accompany the displays, or provide other audio including informational announcements, casino information, news, weather, sports information, broadcasts, etc. The speaker system may or may not be a part of an intercom system, allowing two way audio conversations from the table operator (dealer) or players at the table with other individuals at other locations. If provided, the intercom system may be activated using a switch located with the other switches, such as on the support shaft. For example, the intercom can be used to summon a pit boss, communicate with a bartender to order drinks for players at the table, to request aid or technical assistance, etc.

The service display may also optionally include one or more service lights which can be activated by the table operator or other user. One or more buttons or switches located on the support column may be used to activate the one or more service lights found on the display. In a preferred embodiment, there may be a green service light, which can be activated, for example, so that a server observing the light knows to approach the table to take refreshment orders. There may also be a red service indicator light which can be activated when technical support is needed from a service operator, pit boss, security, etc. The switches activating these service lights may also activate indicators or alarms in separate or central locations for casino management and security purposes.

It is therefore an object of the present invention to provide a display in a location easily observable to casino patrons revealing information regarding table games.

It is also an object of the present invention to provide a casino table display with one or more service lights to allow the table operator to signal for assistance when needed.

It is another object of the present invention to provide a casino table display with advertising panels to provide information to potential customers.

It is another object of the present invention to provide a casino table display unit including an intercom system for voice communications to another location.

It is another object of the present invention to provide a casino table display unit including a speaker system for broadcasting information to patrons in the vicinity of the table.

It is another object of the present invention to provide a casino table display unit which affixes to the underside of a casino table as to save floor space and prevent a potential safety hazard.

It is another object of the present invention to provide a device for displaying advertising and/or information, and providing service requests for use at retail sales counters, restaurants tables and establishments providing drive-through services.

Additional objects of the invention will be apparent from the detailed descriptions and the claims herein.

### BRIEF DESCRIPTION OF THE DRAWINGS

FIG. 1 is a front perspective view of an embodiment of the present invention.

FIG. 2 is a front view of the embodiment of FIG. 1.

FIG. 3 is a side view of one embodiment of FIG. 1.

FIG. 4 is a rear view of the embodiment FIG. 1.

FIG. 5 is a front perspective view of an alternative embodiment of the present invention.

FIG. 6 is a side view of the embodiment of FIG. 5.

### DETAILED DESCRIPTION

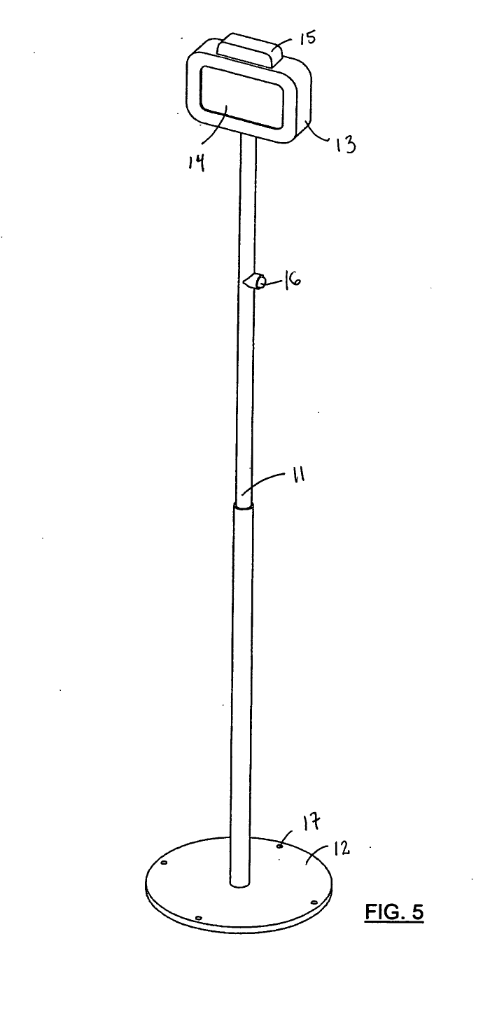

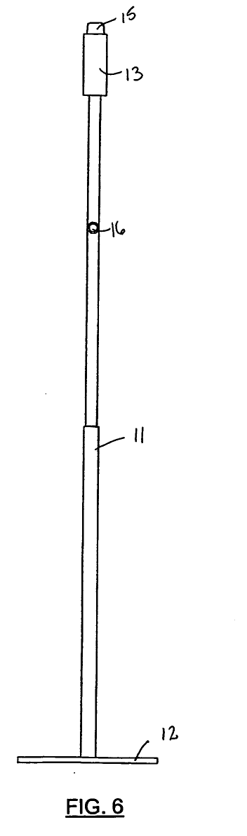

Referring to the drawings wherein like reference characters designate like or corresponding parts throughout the several views, and referring particularly to FIGS. 5 and 6, it is seen that the invention includes a support member 11 designed for deployment in an a generally vertical direction from a mounting base 12 to a display unit 13. The support member 11 may be provided in a tubular or other form, and should have an adjustable length. In a preferred embodiment, the support member has a length which allows the display unit 13 to be above the level of customers standing on a casino floor to allow an unobstructed view of the display unit. In the preferred embodiment, the support member 11 is telescoping in nature, allowing a user to increase or decrease the length of the tubular support to adjust the height of the display unit (the adjustment generally being from about 1 inch to about 4 feet). Locking pins or other devices (not shown) may be used to set the position of telescoping member 11 once its length has been selected.

In the illustrated embodiment of FIGS. 5 and 6, a mounting base 12 with a generally flat surface is secured to the support member 11 to allow the invention to stand on a flat surface, such as a floor of a casino. It is to be appreciated that these embodiments may be inverted and hung from a ceiling. The mounting base 12 is provided with one or more holes 17 allowing for the mounting unit to be secured to the flat surface by the use of fasteners such as nails, screws or the like. The upper surface of the mounting base 12 may be conical in shape to prevent people from tripping on the edge of the mounting unit and to create space for the passage of electrical wires 21 and other connections leading to/from the display unit 13 and switches 6 through support member 11 and base 12 to another location.

At the upper end of the support member 11 is a display unit 13, having one or more generally flat display surfaces 14. These surfaces 14 are used to display information and media. The display 14 can be, but is not limited to, an interchangeable backlit sign, a LED display, or the like. In the embodiment shown, the display unit 13 is rotatable, allowing a user to direct the display unit 13 and the display 14 thereon in a preferred direction.

In alternative embodiments, display unit 13 may be provided with one or more signal lights 15. In a preferred embodiment, a signal light 15 consists of a light and colored translucent enclosure. Such a light, when activated, causes the enclosure to be lit a given color, such as red or green. Different colors may be used to indicate different needs of the table operator. Through use of the one or more signal lights, the operator can signal for the appropriate assistance, without having to leave the gaming table itself. One or more corresponding signal light switches 16 are 16 are located along the support member 11 and allow the table operator to activate and deactivate the signal lights 15. In the illustrated embodiment, signal lights 15 are shown on the top of the display unit 13. However, it is to be appreciated that lights 15 may be of different sizes and shapes, and may be provided in other locations or in multiple locations on display unit 13 such as on one or more sides, the bottom and/or the back. Similarly, switches 16 may be provided at any suitable location on the support member 11, and/or on the display unit 13.

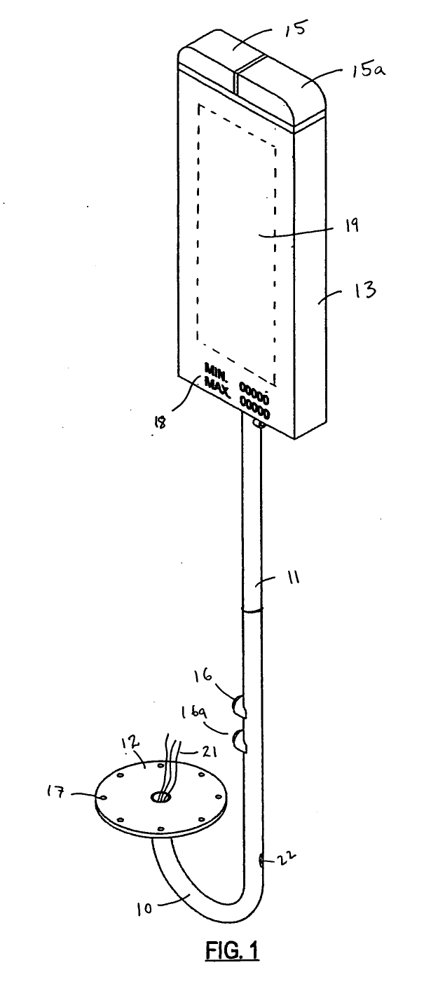

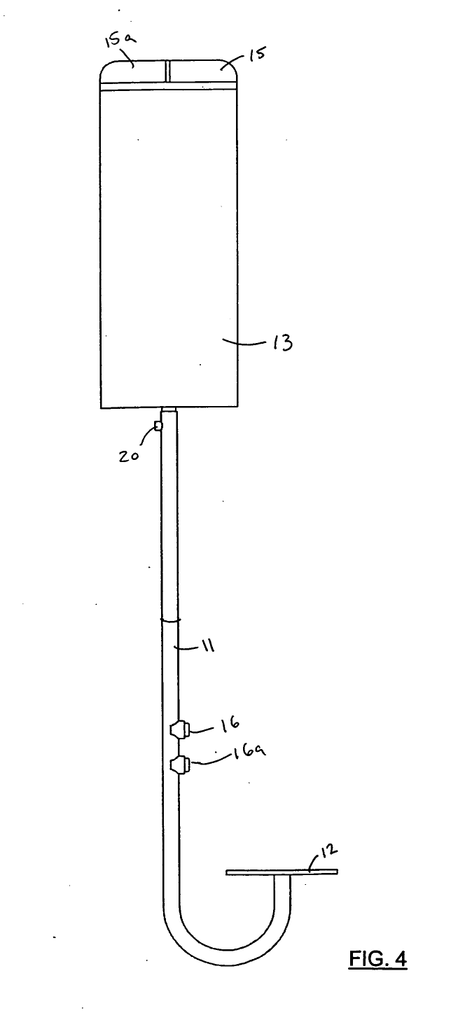

FIGS. 1 through 4 illustrate an alternative embodiment of the casino table display unit. In these embodiments, a portion of support member 11 extends in a generally vertical direction so that one end supports a display unit 13. In some embodiments, this portion of the support member 11 may be telescoping in nature, allowing a user to increase or decrease the length of the support to adjust the height of the display unit 13 mounted at the top. Locking pins or other devices (not shown) may be used to set the position of telescoping member 11 once its length has been selected. In these embodiments another portion 10 of support member 11 is curved so that the opposite end of the support member 11 may be attached to a surface other than the floor, such as the side or underside of a gaming table. A mounting plate or base 12 is provided at the opposite end for use in securing the support member to a surface. Base 12 is provided with a plurality of holes 17 for receiving fasteners for attaching base 12 to a surface. In the illustrated embodiment, the support member curves approximately 180° allowing the base 12 to be attached underneath a gaming table. It is to be appreciated that a curve of approximately 90° would allow the base to be attached to a vertical surface such as a side wall. The curve 10 in support member 11 may be of any angle between zero and 180°, depending on the position of the surface to which base 12 is to be attached. Although the illustrations show the curve 10 near the bottom of support member 11, the curve 10 member 11, the curve 10 may be provided at any location along the support member 11, depending on the location of the surface to which base 12 is to be attached, the desired location of the display unit 13, and any obstacles or space requirements dictated by the location. The bottom of base 12 may also be angled to provide additional mounting flexibility.

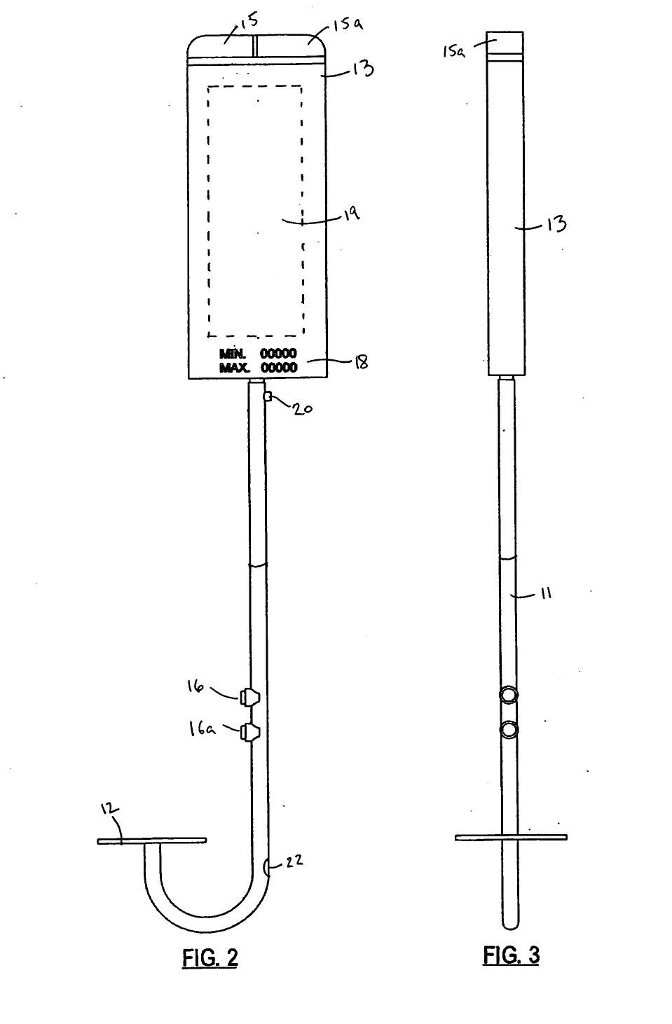

In the alternative embodiments of FIGS. 1-4, the display unit 13 is secured to the top of the support member 11, and may be provided with one or more of the following features: a minimum and maximum bet indicator 18, one or more displays 19 (which may include advertising, game descriptions, or other information), one or more lights 15, one or more speakers, and/or a two-way intercom. The area 19 shown in FIG. 1 may be divided up into one or more displays. The display unit 13 may be rotatably adjustable, allowing it to be turned to face in a,preferred direction. A locking pin 20 may be used to fix the position of unit 13 once it has been rotated in a desired direction. The display unit may be provided with one or more switches 16, 16a corresponding to lights 15, 15a. Wires 21 for providing power, activating the display unit 13 and the various features provided on it, as well as lights 15 and switches 16, are provided inside support member 11 and extend out through base 12 as shown in FIG. 1, or through an access point such as 22 shown in FIG. 2.

In the embodiment illustrated in FIGS. 1-4, switches 16, 16a are shown in vertical arrangement, but other configurations can also be used, such in horizontal configuration or on a console extending from the support member 11. The display 19 can display advertising and/or information regarding the gaming being played. For example, if a gaming tournament is taking place, the display 19 can communicate information regarding the participants of the tournament to the public. Such information can be displayed in the form of chip counts, which describe the number of chips the player has remaining. It is further possible that the one or more displays 19 can communicate different forms of information at the same time. While one display may show chip counts of the players at the table, another display may show advertising. If provided, the two way speaker system provides sound. The sound can accompany the information being provided on the displays, or can provide sound independent of the information provided on the displays. The speaker system may also be in communication with a switch 16b on the support 11 to allow the user to toggle the use of a microphone.

It is to be appreciated that any of the embodiments of the present invention may be adapted for use in other private or commercial enterprises, such as at a check out counter of a retail establishment, at a table at a restaurant, in a drive-through lane (coffee shop, fast food, bank, drug store, etc.) or any other location where the display of information and signals may be needed.

It is to be appreciated that different versions of the invention may be made from different combinations of the various features described above. For example, the display unit 13 illustrated in FIGS. 5-6 may be provided on the curved support member 11 illustrated in FIGS. 1-4, and vice versa. Any number of display areas 14 may be provided the display unit 13, and different combinations, arrangements and locations of other fields of information (such as maximum and minimum betting limits, name or description of the game being played, raise/lower bets, on/off bets, etc.) may be implemented on the display unit 13 without departing from the scope of the invention. Further the support member 11 and mounting unit 12 can be provided in many different formations to allow for the placement of the casino table display unit in many locations.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A display unit comprising:
a. an elongated adjustable telescoping hollow support member having a mounting base at one end and a rotatably mounted electronic unit at an opposite end;
b. at least one changeable display on said electronic unit for displaying information;
c. at least one signal light on said electronic unit; and
d. at least one switch mounted on said support member for controlling said at least one signal light.

2. The display unit of claim 1 wherein the information displayed is selected from the group of: advertising, casino gaming information, instructions, and combinations thereof.

3. The display unit of claim 1 wherein said electronic unit further comprises one of the following: an upper bet limit indicator, a lower bet limit indicator, a game description indicator, a two-way communication system, and combinations thereof.

4. The display unit of claim 1 wherein said base is attached to a floor.

5. The display unit of claim 1 wherein said base is attached to a ceiling.

6. The display unit of claim 1 wherein said support member has a curved section thereon.

7. The display unit of claim 6 wherein said curved section has an angle of about 90° and said base is attached to a generally vertical surface.

8. The display unit of claim 6 wherein said curved section has an angle of about 180° and said base is attached to a generally horizontal surface.

9. The display unit of claim 8 wherein said base is attached underneath a table.

10. The display unit of claim 1 wherein the display on said electronic unit includes LED panels.

11. The display unit of claim 1 wherein the display on said electronic unit includes replaceable back lit panels.

12. The display unit of claim 1 wherein the electronic unit includes speakers for producing sound in connection with the display.

13. A casino table service display panel comprising:
a. an elongated telescoping adjustable hollow tubular support member having a mounting base at one end and a rotatably mounted generally rectangular electronic unit at an opposite end, said base being adapted for attachment to a flat surface;
b. at least one changeable display on said electronic unit for displaying information;
c. upper and lower bet limit indicators on said electronic unit;
d. a game description indicator on said electronic unit;
e. a two-way communication system associated with said unit;
c. at least one signal light on said electronic unit; and
d. at least one switch mounted on said support member for controlling said at least one signal light.

14. The display unit of claim 13 wherein said support member has a curved section thereon.

15. The display unit of claim 14 wherein said curved section has an angle of about 90° and said base is attached to a generally vertical surface.

16. The display unit of claim 14 wherein said curved section has an angle of about 180° and said base is attached to a generally horizontal surface.

17. A display unit comprising:
a. an elongated adjustable telescoping support means having a mounting means at one end and a rotatably mounted electronic unit at an opposite end;
b. at least one changeable display means on said electronic unit for displaying information;
c. at least one signal means on said electronic unit; and
d. at least one control means on said support member for controlling said at least one signal means.

18. The display unit of claim 17 wherein said support means has a curved section thereon.

19. The display unit of claim 17 wherein the information displayed is selected from the group of: advertising, casino gaming information, instructions, and combinations thereof.

20. The display unit of claim 17 wherein said electronic unit further comprises one of the following: an upper bet limit indicator means, a lower bet limit indicator means, a game description indicator means, a means for two-way communication, and combinations thereof.
